(19) United States
(12) Patent Application Publication
(10) Pub. No.: US 2020/0401522 A1
(43) Pub. Date: Dec. 24, 2020

(54) SYSTEMS AND METHODS FOR PROVIDING CONTENT

(71) Applicant: Facebook, Inc., Menlo Park, CA (US)

(72) Inventor: Chenyong Xu, Fremont, CA (US)

(21) Appl. No.: 15/942,127

(22) Filed: Mar. 30, 2018

(51) Int. Cl. G06F 12/0862; G06F 17/30; G06N 99/00

(52) U.S. Cl. CPC G06F 12/0862; G06F 2212/602; G06N 99/005; G06F 17/30902

(57) ABSTRACT

Systems, methods, and non-transitory computer-readable media can determine that a user is interacting with a software application running on a computing device. One or more content items to be prefetched for the software application are identified based on one or more machine learning models. A request to prefetch the one or more content items for the software application is generated.

### FIELD OF THE INVENTION

The present technology relates to the field of content distribution. More particularly, the present technology relates to techniques for distributing content to users in a computer networking environment.

### BACKGROUND

Today, people often utilize computing devices (or systems) for a wide variety of purposes. Users can use their computing devices to, for example, interact with one another, access content, share content, and create content. In some cases, content items can include postings from members of a social network. The postings may include text and media content items, such as images, videos, and audio. The postings may be published to the social network for consumption by others.

Under conventional approaches, users may post various content items to a social networking system. In general, content items posted by a first user can be included in the respective content feeds of other users of the social networking system, for example, that have “followed” the first user. By following (or subscribing to) the first user, some or all content that is produced, or posted, by the first user may be included in the respective content feeds of the following users. A user following the first user can simply unfollow the first user to prevent new content that is produced by the first user from being included in the following user's content feed.

### SUMMARY

Various embodiments of the present technology can include systems, methods, and non-transitory computer readable media configured to determine that a user is interacting with a software application running on a computing device. One or more content items to be prefetched for the software application are identified based on one or more machine learning models. A request to prefetch the one or more content items for the software application is generated.

In an embodiment, the one or more machine learning models are trained based on a set of labels.

In an embodiment, historical instances in which content was prefetched for a particular user and the particular user viewed the prefetched content are positive examples for training the one or more machine learning models.

In an embodiment, historical instances in which content was prefetched for a particular user and the particular user did not view the prefetched content are negative examples for training the one or more machine learning models.

In an embodiment, historical instances in which content was not prefetched for a particular user, and the particular user viewed the content are negative examples for training the one or more machine learning models.

In an embodiment, the identifying one or more content items to be prefetched further comprises identifying, for each content item of the one or more content items, a portion of the content item to be prefetched based on the one or more machine learning models.

In an embodiment, for each content item of the one or more content items, the portion of the content item to be prefetched is determined based on historical user tendencies associated with the user.

In an embodiment, the one or more machine learning models are configured to output a prefetch score indicative of a likelihood of a particular user to view a particular content item.

In an embodiment, the one or more content items to be prefetched are identified based on a determination that the one or more content items satisfy a prefetch score threshold.

In an embodiment, the request is transmitted to a content provider. One or more prefetched content items are received in response to the request. The one or more prefetched content items are stored in a local cache of the computing device.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a content provider module, according to an embodiment of the present technology.

FIG. 2A illustrates an example prefetch model module, according to an embodiment of the present technology.

FIG. 2B illustrates an example smart prefetching module, according to an embodiment of the present technology.

FIG. 3 illustrates an example prefetching module, according to an embodiment of the present technology.

FIG. 4 illustrates example method associated with prefetching of content items, according to an embodiment of the present technology.

FIG. 5 illustrates another example method associated with prefetching of content items, according to an embodiment of the present technology.

FIG. 6 illustrates a network diagram of an example system including an example social networking system that can be utilized in various scenarios, according to an embodiment of the present technology.

FIG. 7 illustrates an example of a computer system or computing device that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Providing Content

People often utilize computing devices (or systems) for a wide variety of purposes. Users can use their computing devices to, for example, interact with one another, access content, share content, and create content. In some cases, content items can include postings from members of a social network. The postings may include text and media content items, such as images, videos, and audio. The postings may be published to the social network for consumption by others.

Under conventional approaches, users may post various content items to the social networking system. In general, content items posted by a first user can be included in the respective content feeds of other users of the social networking system that have “followed” the first user. By following (or subscribing to) the first user, some or all content that is produced, or posted, by the first user may be included in the respective content feeds of the users following the first user. A user following the first user can prevent new content from the first user from being included in the user's content feed by “unfollowing” the first user.

Under conventional approaches, a user typically interacts with the social networking system through a software application running on a computing device. This software application may rely on a network connection (e.g., Internet connection) between the computing device and the social networking system. The software application can utilize the network connection to download content items onto the computing device to be presented through the software application. Certain content items, such as a high resolution images or videos, require large amounts of data to be downloaded. As such, if a user does not have sufficient available computing resources (e.g., bandwidth), such content items may not be able to be downloaded and rendered immediately when a user requests them. In such scenarios, users may experience a delay in viewing the content items. For example, images may be slow to load, or videos may experience stalling or buffering while additional video data is downloaded. Such delays can negatively impact user experience when interacting with the software application.

Certain conventional approaches utilize an approach known as “prefetching” to try to mitigate some of these negative impacts. Prefetching generally involves downloading content items before a user requests them (e.g., before a user attempts to view them) so that they will load more quickly when the user does request them. However, conventional approaches to prefetching are often static and uniform for all users. For certain users, such conventional approaches can result in significant amounts of content being downloaded that will never be viewed by the user, representing a non-optimal use of computing resources. In other instances, conventional approaches may fail to prefetch content that is viewed by a user, resulting in long load times and poor user experience. Accordingly, such conventional approaches may not be effective in addressing these and other problems arising in computer technology.

An improved approach rooted in computer technology overcomes the foregoing and other disadvantages associated with conventional approaches specifically arising in the realm of computer technology. In general, a determination can be made that a user is interacting with a software application on a computing device. The software application can be configured to provide user access to content items received from a content provider using a network connection. For example, the software application can be a social networking system application running on a user mobile device for providing user access to content received from a social networking system. One or more content items associated with the software application, or portions thereof, can be prefetched, i.e., downloaded and stored locally on the user's computing device before the user attempts to view the one or more content items. The one or more content items and/or the portions of the one or more content items to be prefetched can be identified based on one or more machine learning models. The one or more machine learning models can be trained based on past content interaction data to predict, based on user characteristics associated with the user, a likelihood that the user will request and/or view a given content item. Content items (or portions thereof) that have a high likelihood of being viewed by a user (e.g., satisfy a threshold likelihood) can be prefetched. More details relating to the disclosed technology are provided below.

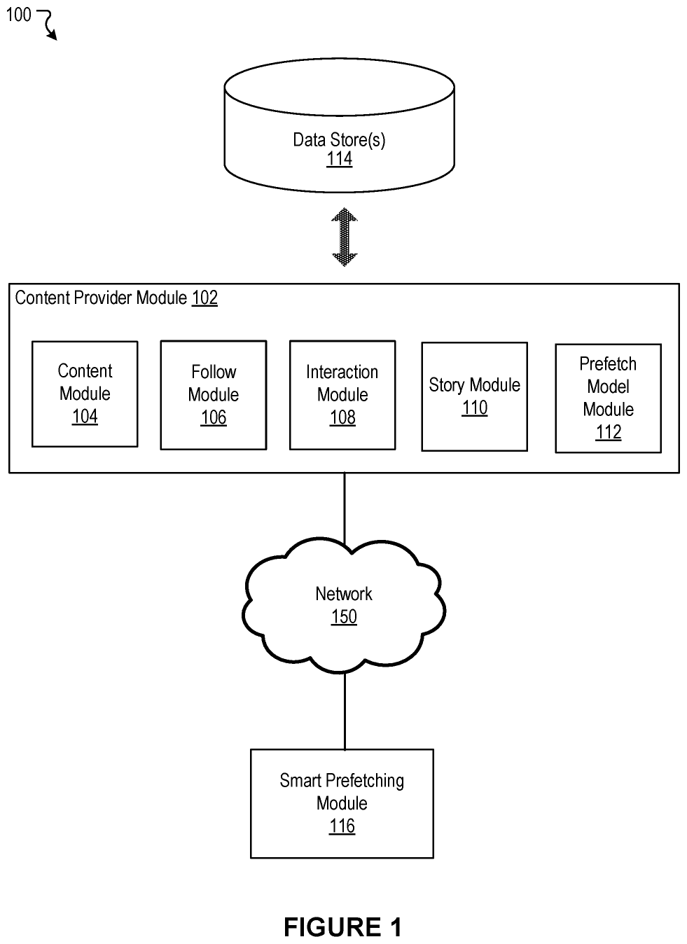

FIG. 1 illustrates an example system 100 including a content provider module 102 and a smart prefetching module 116, according to an embodiment of the present technology. As shown in the example of FIG. 1, the content provider module 102 can include a content module 104, a follow module 106, an interaction module 108, a story module 110, and a prefetch model module 112. In some instances, the example system 100 can include at least one data store 114. The smart prefetching module 116 can interact with the content provider module 102 over one or more networks 150 (e.g., the Internet, a local area network, etc.). The smart prefetching module 116 can be implemented in a software application (e.g., a social networking application) running on a computing device. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the content provider module 102 and/or the smart prefetching module 116 can be implemented in any suitable combinations.

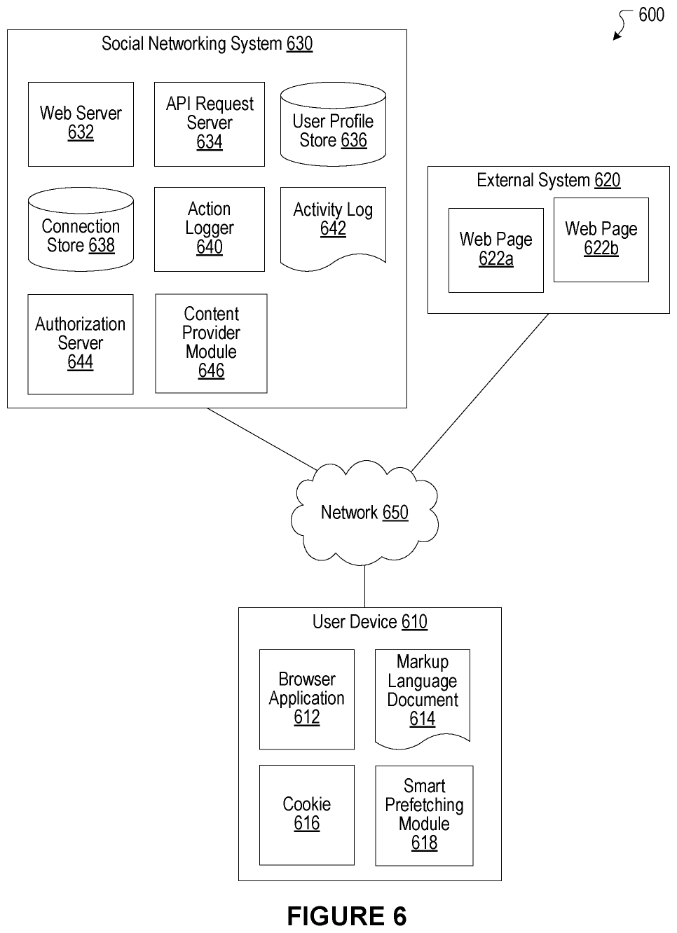

In some embodiments, the content provider module 102 and/or the smart prefetching module 116 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the content provider module 102 and/or the smart prefetching module 116 can be, in part or in whole, implemented as software running on one or more computing devices or systems, such as on a server system or a client computing device. In some instances, the content provider module 102 and/or the smart prefetching module 116 can be, in part or in whole, implemented within or configured to operate in conjunction with or be integrated with a social networking system (or service), such as a social networking system 630 of FIG. 6. Likewise, in some instances, the content provider module 102 and/or the smart prefetching module 116 can be, in part or in whole, implemented within or configured to operate in conjunction with or be integrated with a client computing device, such as the user device 610 of FIG. 6. For example, the content provider module 102 and/or the smart prefetching module 116 can be implemented as or within a dedicated application (e.g., app), a program, or an applet running on a user computing device or client computing system. The application incorporating or implementing instructions for performing functionality of the content provider module 102 and/or the smart prefetching module 116 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The content provider module 102 can be configured to communicate and/or operate with the at least one data store 114, as shown in the example system 100. The data store 114 can be configured to store and maintain various types of data. In some implementations, the data store 114 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data.

The content module 104 can be configured to provide users with access to content that is posted through a content provider (e.g., a social networking system). For example, the content module 104 can provide a first user with access to content items through an interface. This interface may be provided through a display of a computing device being accessed by the first user in which the smart prefetching module 116 is implemented. The first user can also interact with the interface to post content items to the social networking system. Such content items may include text, images, audio, and videos, for example. For example, the first user can submit a post to be published through the social networking system. In some embodiments, the post can include, or reference, one or more content items.

In various embodiments, other users of a social networking system can access content items posted by the first user. In one example, the other users can access the content items by searching for the first user by user name through an interface provided by a software application (e.g., a social networking application, browser, etc.) running on their respective computing devices. In some instances, some users may want to see content items posted by the first user in their respective content feed. To cause content items posted by the first user to be included in their respective content feed, a user can select an option through the interface to subscribe to, or “follow”, the first user. The follow module 106 can process the user's request by identifying the user as a follower of (or “friend” of) the first user in the social networking system. As a result, some or all content items that are posted by the first user can automatically be included in the respective content feed of the user. If the user decides that they no longer want to see content from the first user in their respective content feed, the user can select an option through the interface to unsubscribe from, or “unfollow”, the first user. As a result, the follow module 106 can remove the association between the user and the first user so that content items posted by the first user are no longer included in the content feed of the user.

In some instances, users may want to interact with posted content items. For example, a user may want to endorse, or “like”, a content item. In this example, the user can select an option provided in the interface to like the desired content item. The interaction module 108 can determine when a user likes a given content item and can store information describing this relationship. The interaction module 108 can also determine when other forms of user interaction are performed and can store information describing the interaction (e.g., information describing the type of interaction, the identity of the user, the identity of the user that posted the content item, and the content item, to name some examples). For example, the user may want to post a comment in response to a content item. In this example, the user can select an option provided in the interface to enter and post the comment for the desired content item. The interaction module 108 can determine when a user posts a comment in response to a given content item and can store information describing this relationship. Other forms of user interaction can include emoji-based reactions to a content item (e.g., selecting an option that corresponds to a particular reaction emoji, e.g., happy, sad, angry, etc.) and re-sharing a content item, for example. In some embodiments, such information can be stored in a social graph as described in reference to FIG. 6.

In some embodiments, the story module 110 can provide an option that allows users to post their content as stories. In such embodiments, each user has a corresponding story feed in which the user can post content. When a user's story feed is accessed by another user, the story module 110 can provide content posted in the story feed to the other user for viewing. In general, content posted in a user's story feed may be accessible by any user of the social networking system. In some embodiments, content posted in a user's story feed may only be accessible to followers of the user. In some embodiments, user stories expire after a pre-defined time interval (e.g., after 24 hours). In such embodiments, content posted as a story in a story feed is treated as ephemeral content that is made inaccessible once the pre-defined time interval has elapsed. In contrast, content posted in a user (or follower) primary content feed can be treated as non-ephemeral content that remains accessible for a longer and/or an indefinite period of time.

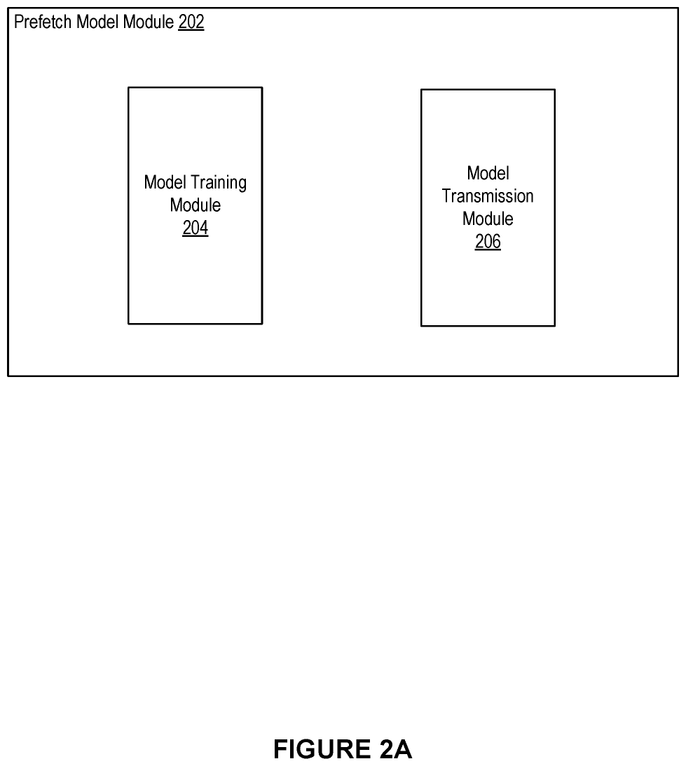

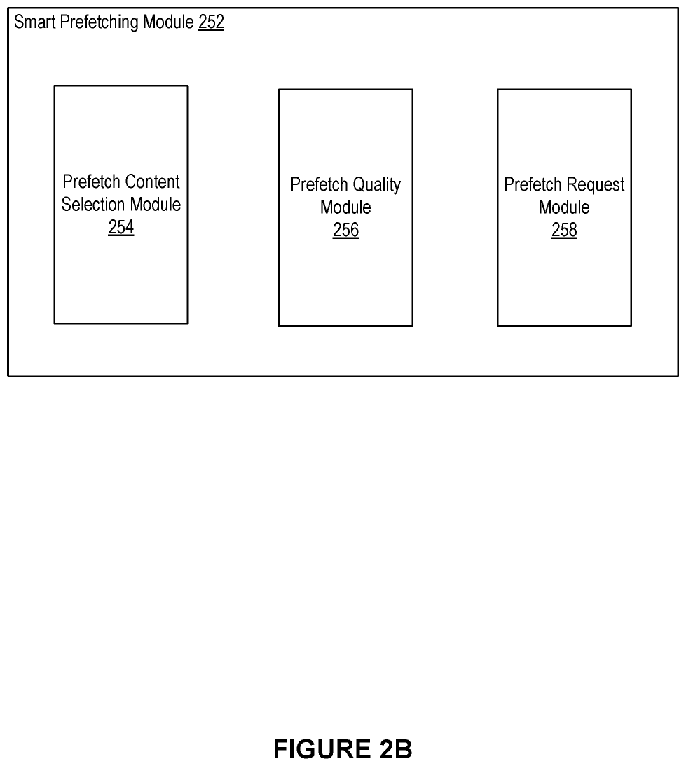

In various embodiments, the prefetch model module 112 is configured to train one or more machine learning models (which may collectively be referred to herein as a “prefetch model”) based on training data. More details regarding the prefetch model module 112 will be provided below with reference to FIG. 2A.

In various embodiments, the smart prefetching module 116 is configured to provide functionality for prefetching content provided by the content provider module 102 based on one or more machine learning models (e.g., a prefetch model). More details regarding the smart prefetching module 116 will be provided below with reference to FIG. 2B.

FIG. 2A illustrates an example prefetch model module 202 according to an embodiment of the present technology. In some embodiments, the prefetch model module 112 of FIG. 1 can be implemented as the prefetch model module 202. As shown in the example of FIG. 2A, the prefetch model module 202 can include a model training module 204 and a model transmission module 206.

The model training module 204 can be configured to train one or more machine learning models (i.e., a prefetch model) based on training data. In various embodiments, the training data can comprise historical content interaction information. Historical content interaction information can include, for example, information pertaining to past occurrences in which users have interacted with content from a content provider (e.g., using a software application running on a computing device) and/or past occurrences in which content from the content provider has been prefetched for users. In some instances, the model training module 204 can receive such training data from a plurality of computing devices associated with a plurality of users. Each occurrence included in the training data can be associated with a particular user and a particular content item. For example, each occurrence can be associated with an instance in which a user interacted with a content item (e.g., viewed the content item), or an instance in which a content item was prefetched for the user, but the user did not interact with the content item (e.g., did not view the content item). Each user can be associated with a set of user information or user characteristics. Similarly, each content item can be associated with a set of content information or content characteristics. The prefetch model can be trained to determine a likelihood that a user, having a particular set of user characteristics, will view content (e.g., a content item, or a portion of a content item) having a particular set of content characteristics.

The model training module 204 can train a prefetch module based on one or more labels. In an embodiment, a prefetch model can be trained based on binary labeling of previous occurrences of content interaction as positive or negative examples. In one example, an occurrence in which content was prefetched and subsequently viewed by a user can be labeled as a positive example to train the prefetch model. Conversely, an occurrence in which content was prefetched, but never viewed by a user can be labeled as a negative example. Similarly, an occurrence in which content was not prefetched, but subsequently viewed by a user, can also be labeled as a negative example.

Training data can include structured data pertaining to past occurrences of content interaction by users and/or content prefetching, and the structured data can be selected as features for training the prefetch model. The structured data can include any number of user characteristics, content characteristics, or other characteristics believed to be relevant to the ultimate determination of likelihood of a content item (or portion of a content item) to be viewed by a user. Relevant user characteristics can include, for example, a user's available bandwidth or network connection quality, the user's historical viewing tendencies (e.g., on average, how many videos will a user watch in a single viewing session, and what portion of each video will the user watch on average), the user's location, a current content item being viewed by the user when content was prefetched, a number of content items (e.g., videos) that had been viewed by the user in a viewing session when content was prefetched, how long the user had been engaged in a viewing session when content was prefetched, and the like.

Another user characteristic that can be used to train a prefetch model can include a user interface surface being viewed by the user when content was prefetched. For example, a software application, such as a social networking system application, can include multiple surfaces for presenting content to a user. Some examples of surfaces can include a primary content feed and a story feed, as have been described previously. Whether a user is currently in the primary content feed or currently in the story feed may be relevant to the ultimate determination of the prefetch model, as a user currently in the primary content feed may be more likely to view content prefetched for the primary content feed, whereas a user currently in the story feed may be more likely to view content prefetched for the story feed.

Another characteristic that can be used to train a prefetch model is a metric indicative of a user's predicted interest in a content item, e.g., a content affinity score. The content affinity score can be determined, for example, based on a user's viewing history, the user's interaction history, the user's profile information, the user's stated interests, and the like. The content affinity score may be a score that is determined based on another machine learning model that is trained to determine a content affinity score for a particular user with respect to a particular content item indicative of the particular user's predicted interest in the particular content item. Content affinity scores may provide a useful indicator of a likelihood of a user to view a content item (e.g., content with a relatively high content affinity score may result in a higher likelihood of a user viewing the content item).

Other information that can be used to train a prefetch model can pertain to results information for historical content interactions. For example, the training data can include stall ratio information (e.g., buffering time divided by total view time for a particular video, or for a particular viewing session) and/or prefetch to play ratio (e.g., amount of video content that is prefetched divided by amount of prefetched video content that is played).

As mentioned above, the model training module 204 can be trained to determine a prefetch metric (e.g., a prefetch score) indicative of a likelihood that a particular user will view a particular content item, or portion of a content item. As will be described in greater detail herein, particularly with reference to FIG. 2B, the prefetch model can also be configured to determine a set of content items to prefetch, including how many content items to prefetch, and what portion of each content item to prefetch. Determining a portion of a content item to be prefetched can include, in various examples, determining a percentage or fraction of a content item to be prefetched, determining a certain length of time of the content item to be prefetched (e.g., first 30 seconds of a video), and/or determining whether or not to prefetch the entire content item. It should be understood that, in accordance with the present technology, a “portion” of a content item can include the entire content item, i.e., 100% of the content item, or less than the entire content item. For example, the prefetch model can determine that three particular content items should be prefetched for a user based on the user's likelihood to view those content items (e.g., based on prefetch scores for those content items). Further, based on the user's likelihood to view portions of the content items, the prefetch model can determine that for a first content item, the first half should be prefetched; for a second content item, the entire content item should be prefetched; and, for a third content item, the first ten seconds should be prefetched.

The model transmission module 206 can be configured to transmit (e.g., distribute, download, etc.) a trained prefetch model to a plurality of computing devices associated with a plurality of users. As mentioned, in certain embodiments, each computing device can include a software application that a user can utilize to view content items provided by a content provider. By distributing the trained prefetch model to each computing device, each computing device can utilize the trained prefetch model to determine, for a particular user, which content items to prefetch and what portions of each content item to prefetch. The computing device (e.g., the software application running on the computing device) can generate a request to a content provider for prefetched content based on the prefetch model, as will be described in greater detail below with reference to FIG. 2B. In certain embodiments, training of the prefetch model can be periodically updated based on updated training data. The model transmission module 206 can periodically distribute updated prefetch models to the plurality of computing devices.

FIG. 2B illustrates an example smart prefetching module 252 according to an embodiment of the present technology. In some embodiments, the smart prefetching module 116 of FIG. 1 can be implemented as the smart prefetching module 252. As shown in the example of FIG. 2B, the smart prefetching module 252 can include a prefetch content selection module 254, a prefetch quality module 256, and a prefetch request module 258. In an embodiment, the smart prefetching module 252, or one or more functions thereof, may be implemented in a software application (e.g., social networking application) running on a computing device.

The prefetch content selection module 254 can be configured to determine content to be prefetched for a user based on a prefetch model. The content to be prefetched can include portions of one or more content items that a user has not yet viewed and/or requested. As discussed above, a prefetch model can be trained to determine, for a particular user and a particular content item, a likelihood that the user will view the content item. This determination can be made based on various user characteristics associated with the user, content characteristics associated with the content item, or other characteristics believed to be relevant to the ultimate determination of likelihood of the content item (or portion of a content item) being viewed by the user, as discussed. Some examples of information used to determine content to be prefetched can include, for example, a user's available bandwidth or network connection quality, the user's historical viewing tendencies (e.g., on average, how many videos the user will watch in a single viewing session, and what portion of each video will the user watch on average), the user's location, a current content item being viewed by the user, a number of content items (e.g., videos) that have been viewed by the user in a current viewing session, how long the user has been engaged in a current viewing session, a current user interface surface being viewed and/or accessed by the user, a content affinity score between the user and the content item, and the like.

The prefetch content selection module 254 can identify a set of potential content items that could potentially be prefetched for a user. The set of potential content items can include one or more content items that have not yet been viewed and/or requested by the user. For example, in a content feed, the set of potential content items can include content items that are upcoming in the content feed. The prefetch content selection module 254 can utilize a trained prefetch model to determine, for each content item of the set of potential content items, a likelihood that the user will view the content item. For example, in an embodiment, the trained prefetch model can output a prefetch score for each content item in the set of potential content items indicative of a likelihood that the user will view the content item. Based on the likelihood determinations, the prefetch content selection module 254 can identify one or more content items to prefetch. For example, content items which satisfy a minimum likelihood threshold (e.g., a prefetch score threshold) can be selected for prefetching. Furthermore, in certain embodiments, the prefetch content selection module 254 can utilize the trained prefetch model to determine what portion of each content item should be prefetched. For example, if a user typically only watches the first ten seconds of each video the user opens, the prefetch content selection module 254 can determine that only the first ten seconds of each video identified for prefetching should be prefetched. Conversely, if a user typically watches each video in its entirety, the prefetch content selection module 254 can determine that each content item identified for prefetching should be prefetched in its entirety.

In certain embodiments, the prefetch content selection module 254 can also determine how many content items to prefetch. This may be done, in one embodiment, based on historical user tendencies. For example, if twenty content items satisfy the minimum likelihood threshold, but the user typically only views 4 or 5 videos in a single viewing session, it is unlikely that the user will view all twenty content items if they are prefetched. As such, the prefetch model can be trained, based on historical user behavior, to determine a maximum number of content items to be prefetched. For example, if a user typically only views five videos in one session, the prefetch model can determine that a maximum of five videos should be prefetched, such that only the top five content items by prefetch score are identified for prefetching. Or, in another example, if the user typically only views five videos in one session, and the user is currently viewing his or her fourth video of the current session, the prefetch model can determine that only one or two additional videos should be prefetched, as the user's current session is likely to end soon.

The prefetch quality module 256 can be configured to determine a quality level at which to prefetch content items. In certain instances, content items may have multiple quality levels that can be downloaded. For example, a video may be encoded at multiple levels of quality. In one embodiment, the prefetch quality module 256 can determine a quality level for one or more content items to be prefetched based on a network connection quality. For example, if a user's computing device has a relatively large amount of bandwidth available and/or the user's network connection is relatively strong, the prefetch quality module 256 can determine that a relatively high quality level can be requested for the content items to be prefetched. Conversely, if the user's computing device has a relatively small amount of bandwidth available and/or the network connection is relatively weak, the prefetch quality module 256 can determine that a relatively low quality level should be requested for the content items to be prefetched.

The prefetch request module 258 can be configured to generate and transmit a request for one or more content items to be prefetched. The prefetch request module 258 can receive a determination by the prefetch content selection module 256 of content to be prefetched (e.g., portions of one or more content items to be prefetched), and a determination by the prefetch quality module 256 of a quality level to request for the content to be prefetched. The prefetch request module 258 can generate a prefetch request consistent with those determinations, and transmit the request to a content provider. In response to the request, the prefetch request module 258 can receive the requested prefetched content from the content provider. The prefetched content can be stored locally on a computing device (e.g., in a local cache). When a user takes an action that results in viewing and/or requesting of a prefetched content item, the prefetched content item can be loaded from the local cache. For example, consider an example scenario in which a content item has been prefetched for presentation in a content feed. If the user scrolls within the content feed to a position in which the prefetched content item is to be presented, the prefetched content item can be loaded from the local cache and presented to the user. In certain embodiments, as described previously herein, a prefetched content item may comprise a less than complete portion of a content item. For example, only 50% of a content item may have been prefetched, such that the prefetched content item represents 50% of the content item. In such scenarios, as the viewer is viewing the partially prefetched content item, the remainder of the content item can be received from the content provider. For example, as a user is viewing the first half of a video that was prefetched, the second half of the video can be retrieved from the content provider.

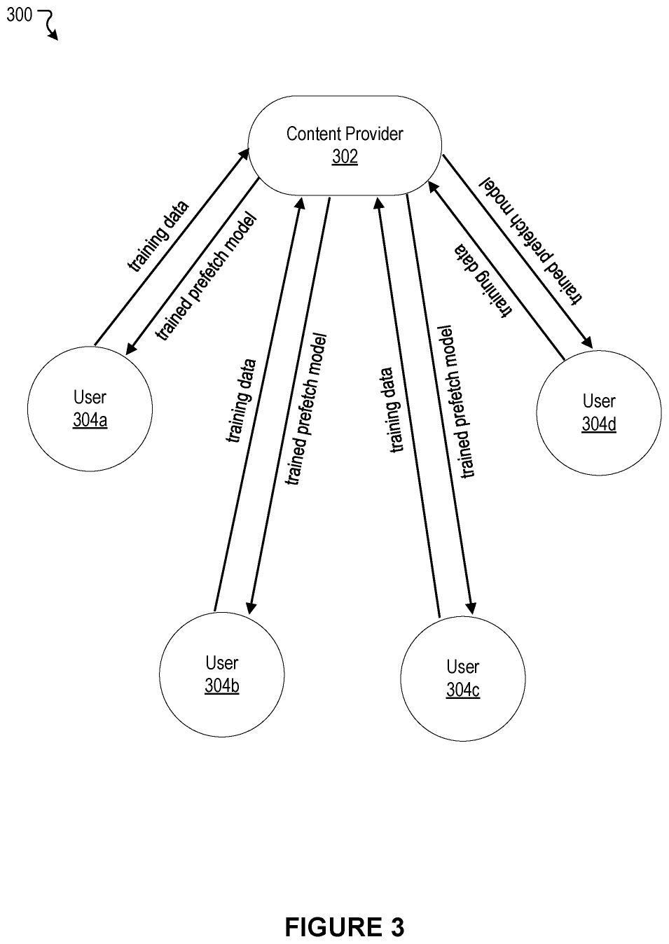

FIG. 3 illustrates an example functional block diagram 300 associated with training and transmitting a prefetch model, according to an embodiment of the present technology. The functional block diagram 300 may represent steps that are taken, for example, by the prefetch model module 112. In the example functional block diagram 300, a content provider 302 receives training data from a plurality of user computing devices 304a-d. The training data can include, for example, information pertaining to historical instances in which users have interacted with content and/or content has been prefetched for users. A prefetch model can be trained based on the training data. The trained prefetch model can then be transmitted to the plurality of user computing devices 304a-d. The plurality of user computing devices 304a-d can utilize the trained prefetch model to generate prefetch requests.

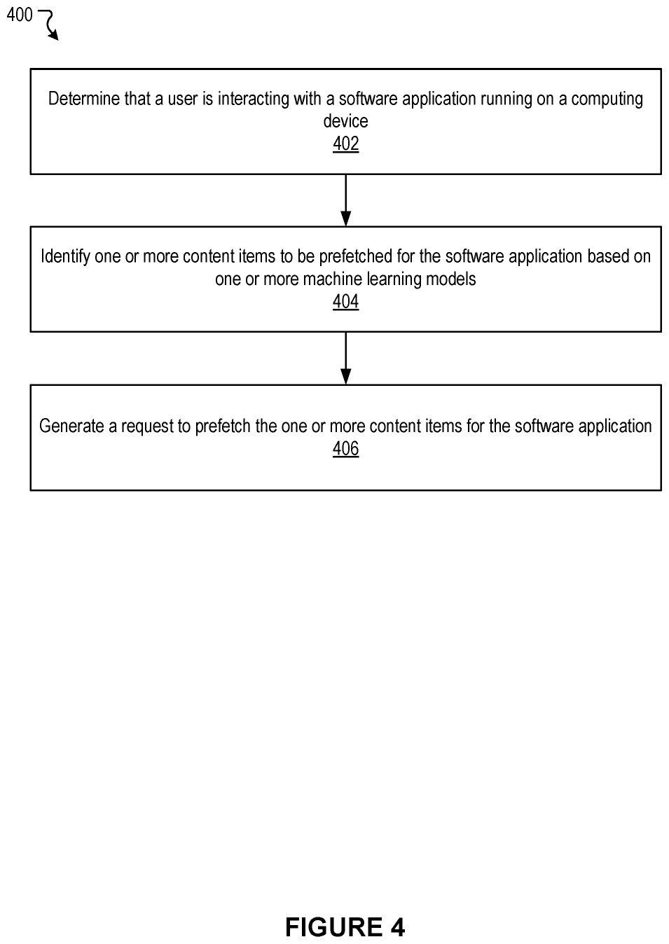

FIG. 4 illustrates an example method 400 associated with prefetching of content items based on a machine learning model, according to an embodiment of the present technology. It should be appreciated that there can be additional, fewer, or alternative steps performed in similar or alternative orders, or in parallel, within the scope of the various embodiments discussed herein unless otherwise stated.

At block 402, the example method 400 can determine that a user is interacting with a software application running on a computing device. At block 404, the example method 400 can identify one or more content items to be prefetched for the software application based on one or more machine learning models. At block 406, the example method 400 can generate a request to prefetch the one or more content items for the software application.

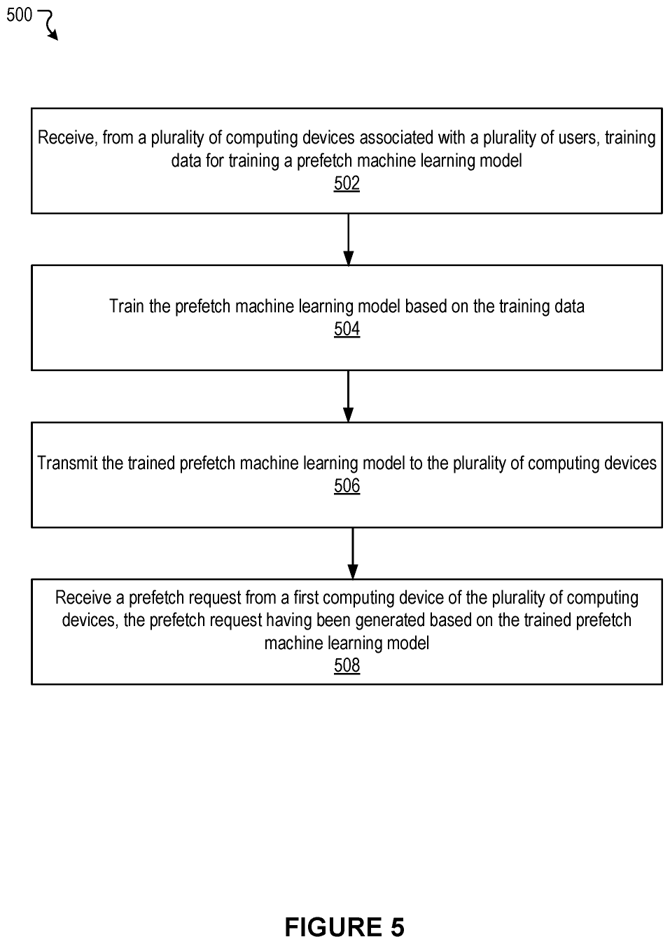

FIG. 5 illustrates an example method 500 associated with prefetching of content items based on one or more machine learning models, according to an embodiment of the present technology. It should be appreciated that there can be additional, fewer, or alternative steps performed in similar or alternative orders, or in parallel, within the scope of the various embodiments discussed herein unless otherwise stated.

At block 502, the example method 500 can receive, from a plurality of computing devices associated with a plurality of users, training data for training a prefetch machine learning model. At block 504, the example method 500 can train the prefetch machine learning model based on the training data. At block 506, the example method 500 can transmit the trained prefetch machine learning model to the plurality of computing devices. At block 508, the example method 500 can receive a prefetch request from a first computing device of the plurality of computing devices, the prefetch request having been generated based on the trained prefetch machine learning model.

It is contemplated that there can be many other uses, applications, and/or variations associated with the various embodiments of the present technology. For example, in some cases, user can choose whether or not to opt-in to utilize the disclosed technology. The disclosed technology can also ensure that various privacy settings and preferences are maintained and can prevent private information from being divulged. In another example, various embodiments of the present technology can learn, improve, and/or be refined over time.

### Social Networking System—Example Implementation

FIG. 6 illustrates a network diagram of an example system 600 that can be utilized in various scenarios, according to an embodiment of the present technology. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a content provider module 646. The content provider module 646 can, for example, be implemented as the content provider module 102, as discussed in more detail herein. In some embodiments, one or more functionalities of the content provider module 646 can be implemented in the user device 610. In some embodiments, the user device 610 can include a smart prefetching module 618. The smart prefetching module 618 can, for example, be implemented as the smart prefetching module 116, as discussed in more detail herein. In some embodiments, one or more functionalities of the smart prefetching module 618 can be implemented in the social networking system 630. As discussed previously, it should be appreciated that there can be many variations or other possibilities.

### Hardware Implementation

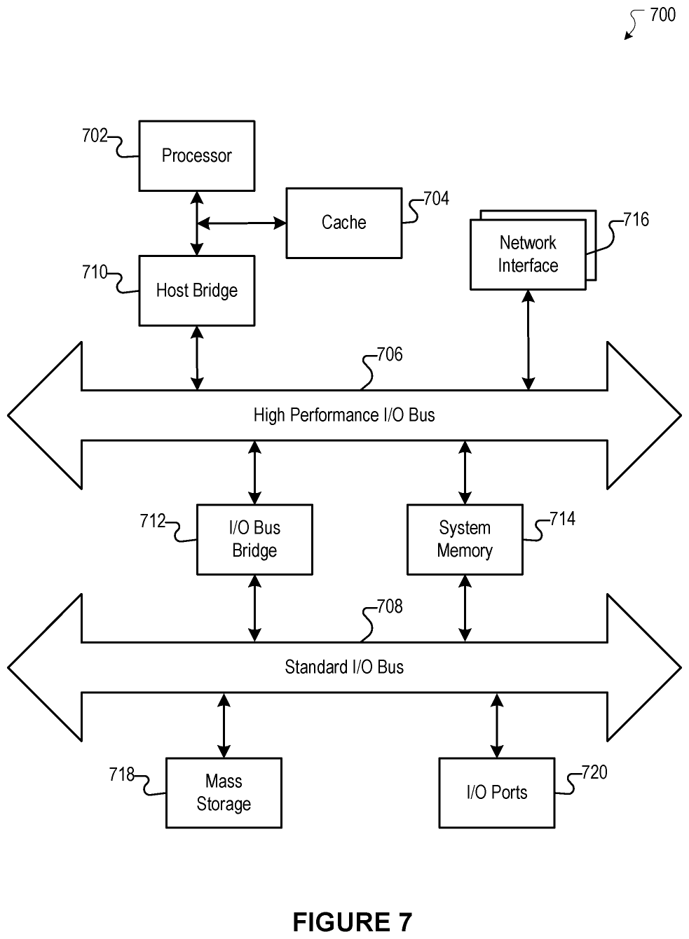

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the presently disclosed technology can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the presently disclosed technology. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
training, by a computing system, a prefetch machine learning model based on training data received from a plurality of computing devices associated with a plurality of users,
wherein the training data includes user characteristics and labeling of previous occurrences of content interaction as examples,
wherein the user characteristics include content affinity scores determined based on an affinity machine learning model, a content affinity score being indicative of a user's predicted interest in a content item;
determining, by the computing system, that a first user is interacting with a software application running on a computing device;
identifying, by the computing system, one or more content items to be prefetched for the software application based on prefetch scores generated by the prefetch machine learning model, a prefetch score being indicative of a likelihood of the first user to view a content item; and
generating, by the computing system, a request to prefetch the one or more content items for the software application.

2. The computer-implemented method of claim 1, wherein the prefetch machine learning model is trained based on a set of labels.

3. The computer-implemented method of claim 2, wherein historical instances in which content was prefetched for a particular user and the particular user viewed the prefetched content are positive examples for training the prefetch machine learning model.

4. The computer-implemented method of claim 2, wherein historical instances in which content was prefetched for a particular user and the particular user did not view the prefetched content are negative examples for training the prefetch machine learning model.

5. The computer-implemented method of claim 2, wherein historical instances in which content was not prefetched for a particular user, and the particular user viewed the content are negative examples for training the prefetch machine learning model.

6. The computer-implemented method of claim 1, wherein the identifying the one or more content items to be prefetched further comprises
identifying, for each content item of the one or more content items, a portion of the content item to be prefetched based on the prefetch machine learning model.

7. The computer-implemented method of claim 6, wherein, for each content item of the one or more content items, the portion of the content item to be prefetched is determined based on historical user tendencies associated with the user.

8. (canceled)

9. The computer-implemented method of claim 1, wherein the one or more content items to be prefetched are identified based on a determination that the one or more content items satisfy a prefetch score threshold.

10. (canceled)

11. A system comprising:
at least one processor; and
a memory storing instructions that, when executed by the at least one processor, cause the system to perform a method comprising:
training a prefetch machine learning model based on training data received from a plurality of computing devices associated with a plurality of users,
wherein the training data includes user characteristics and labeling of previous occurrences of content interaction as examples,
wherein the user characteristics include content affinity scores determined based on an affinity machine learning model, a content affinity score being indicative of a user's predicted interest in a content item;
determining that a first user is interacting with a software application running on a computing device;
identifying one or more content items to be prefetched for the software application based on prefetch scores generated by the prefetch machine learning model, a prefetch score being indicative of a likelihood of the first user to view a content item; and
generating a request to prefetch the one or more content items for the software application.

12. The system of claim 11, wherein the prefetch machine learning model is trained based on a set of labels.

13. The system of claim 12, wherein historical instances in which content was prefetched for a particular user and the particular user viewed the prefetched content are positive examples for training the prefetch machine learning model.

14. The system of claim 12, wherein historical instances in which content was prefetched for a particular user and the particular user did not view the prefetched content are negative examples for training the prefetch machine learning model.

15. The system of claim 12, wherein the minimum background time threshold wherein historical instances in which content was not prefetched for a particular user, and the particular user viewed the content are negative examples for training the prefetch machine learning model.

16. A non-transitory computer-readable storage medium including instructions that, when executed by at least one processor of a computing system, cause the computing system to perform a method comprising:
training a prefetch machine learning model based on training data received from a plurality of computing devices associated with a plurality of users,
wherein the training data includes user characteristics and labeling of previous occurrences of content interaction as examples,
wherein the user characteristics include content affinity scores determined based on an affinity machine learning model, a content affinity score being indicative of a user's predicted interest in a content item;
determining that a first user is interacting with a software application running on a computing device;
identifying one or more content items to be prefetched for the software application based on prefetch scores generated by the prefetch machine learning model, a prefetch score being indicative of a likelihood of the first user to view a content item; and
generating a request to prefetch the one or more content items for the software application.

17. The non-transitory computer-readable storage medium of claim 16, wherein the prefetch machine learning model is trained based on a set of labels.

18. The non-transitory computer-readable storage medium of claim 17, wherein historical instances in which content was prefetched for a particular user and the particular user viewed the prefetched content are positive examples for training the prefetch machine learning model.

19. The non-transitory computer-readable storage medium of claim 17, wherein historical instances in which content was prefetched for a particular user and the particular user did not view the prefetched content are negative examples for training the prefetch machine learning model.

20. The non-transitory computer-readable storage medium of claim 17, wherein historical instances in which content was not prefetched for a particular user, and the particular user viewed the content are negative examples for training the prefetch machine learning model.

21. The system of claim 11, wherein the one or more content items to be prefetched are identified based on a determination that the one or more content items satisfy a prefetch score threshold.

22. The non-transitory computer-readable storage medium of claim 16, wherein the one or more content items to be prefetched are identified based on a determination that the one or more content items satisfy a prefetch score threshold.
